(19) United States
(12) Patent Application Publication
(10) Pub. No.: US 2026/0110201 A1
(43) Pub. Date: Apr. 23, 2026

(54) APPARATUSES AND METHODS FOR LOCKING A DOOR

(71) Applicant: John William GUSTI, Roanoke, TX (US)

(72) Inventor: John William GUSTI, Roanoke, TX (US)

(21) Appl. No.: 19/362,247

(22) Filed: Oct. 17, 2025

Related U.S. Application Data
(60) Provisional application No. 63/708,642, filed on Oct. 17, 2024.

(51) Int. Cl. E05C 19/00

(52) U.S. Cl. CPC E05C 19/003

(57) ABSTRACT

An apparatus for locking a door. The apparatus includes a first base having a first connecting bar, a first door slot to accommodate the door, and a first cutout configured to engage a side of a door frame. The first connecting bar has one or more apertures. The apparatus includes a second base having a second connecting bar, a second door slot to accommodate the door, and a second cutout to engage an opposing side of the door frame. The second connecting bar has one or more apertures. The first connecting bar is slidably engaged with the second connecting bar, and the one or more apertures of the first connecting bar are configured to align with the one or more apertures of the second connecting bar when the first cutout and the second cutout are engaged with the door frame. The aligned apertures can be configured to receive a lock.

### CROSS-REFERENCE TO RELATED APPLICATIONS

This application claims the benefit of provisional U.S. Application No. 63/708,642 entitled “Apparatuses and Methods for Locking a Door” filed Oct. 17, 2024, the technical disclosure of which is incorporated herein by reference in its entirety.

### BACKGROUND

### Technical Field

The present disclosure relates to apparatuses for locking doors, and particularly to apparatuses for locking doors from the exterior or interior.

### Description of Related Art

Conventional door locks rely on doorknob locks or deadbolts to lock doors to a doorway. However, these conventional locks can still leave a door susceptible to being broken into (e.g., kicking the door in). While door reinforcements can be used to increase door security, these apparatuses are typically permanent fixtures and can only be used on a particular side of the door. Therefore, a need exists for a door lock that increases the structural security of the door and is adaptable for use in different configurations.

### BRIEF SUMMARY

This summary provides a discussion of aspects of certain embodiments of the invention. It is not intended to limit the claimed invention or any of the terms in the claims. The summary provides some aspects, but there are aspects and embodiments of the invention that are not discussed here.

In one aspect, an apparatus for locking a door is provided. The apparatus can include a first base having a first connecting bar and a first door slot to accommodate the door. The first connecting bar can have one or more apertures. The first base can also have a first cutout configured to engage a first side of a door frame. The apparatus can also include a second base having a second connecting bar and a second door slot to accommodate the door. The second connecting bar can have one or more apertures. The second base can also have a second cutout to engage an opposing second side of the door frame. The first connecting bar can be slidably engaged with the second connecting bar, and the one or more apertures of the first connecting bar can be configured to align with the one or more apertures of the second connecting bar when the first cutout and the second cutout are engaged with the door frame. The aligned apertures can be configured to receive a lock.

The first base further can also have a first set of rails that define the first door slot, and the second base can also have a second set of rails that define the second door slot.

The first base can also have a first set of lateral protrusions that define the first cutout, and the second base can also have a second set of lateral protrusions that define the second cutout.

The one or more apertures of the first connecting bar can include a first aperture corresponding to a 24-inch door, a second aperture corresponding to a 28-inch door, a third aperture corresponding to a 30-inch door, a fourth aperture corresponding to a 32-inch door, a fifth aperture corresponding to a 36-inch door, or any combination thereof. The one or more apertures of the second connecting bar can be a single aperture. The first connecting bar can be sized and configured to slide within the second connecting bar.

The first connecting bar and the second connecting bar can substantially contain a lock shackle of the lock. In one embodiment, the first connecting bar and the second connecting bar can entirely contain a lock shackle of the lock.

The apparatus can be configured to slide under a bottom end of the door. Additionally, or alternatively, the apparatus can be configured to slide over a top end of the door.

The first connecting bar and the second connecting bar can be positioned on an exterior side of the door. The first connecting bar and the second connecting bar can be in a parallel plane with the door.

The first connecting bar and the second connecting bar can be positioned on an interior side of the door. The first connecting bar and the second connecting bar can be in a plane having an angle of less than 90 degrees with the door. In one embodiment, the angle is between about 30 degrees to about 60 degrees.

In another aspect, a method for locking a door with an apparatus is provided. The method can include positioning the door within a door slot of the apparatus and closing the door against a door frame. Next, a first base of the apparatus can be secured with a first side of the door frame, and a second base of the apparatus can be secured with an opposing second side of the door frame. A first connecting bar of the first base can be slidably engaged with a second connecting bar of the second base, whereby an aperture in the first connecting bar can be aligned with an aperture in the second connecting bar. Next, a lock shackle of a lock can be inserted through the aligned apertures to lock the door.

Positioning the door within the door slot can include sliding the apparatus underneath the door. Additionally, or alternatively, positioning the door within the door slot can include the first connecting bar and the second connecting bar being positioned on an exterior side of the door. Additionally, or alternatively, positioning the door within the door slot can include the first connecting bar and the second connecting bar being positioned on an interior side of the door.

Positioning the door within the door slot can include sliding the apparatus over a top of the door. Additionally, or alternatively, positioning the door within the door slot can include the first connecting bar and the second connecting bar being positioned on an exterior side of the door. Additionally, or alternatively, positioning the door within the door slot can include the first connecting bar and the second connecting bar being positioned on an interior side of the door.

Securing the first base of the apparatus with the first side of the door frame can include extending the first base away from a center of the apparatus, and securing the second base of the apparatus with the second side of the door frame comprises extending the second base away from the center of the apparatus. Additionally, a first cutout formed in the first base can be configured to engage with the first side of the door frame, and a second cutout formed in the second base can be configured to engage with a second side of the door frame.

### BRIEF DESCRIPTION OF THE DRAWINGS

The preceding aspects and many of the attendant advantages of the present technology will become more readily appreciated by reference to the following Detailed Description when taken in conjunction with the accompanying simplified drawings of example embodiments. The drawings briefly described below are presented for ease of explanation and do not limit the scope of the claimed subject matter.

FIG. 1 depicts an embodiment of an apparatus for locking a door.

FIG. 2 depicts an alternative embodiment of an apparatus for locking a door.

FIG. 3 depicts an alternative embodiment of an apparatus for locking a door.

FIG. 4 depicts an embodiment of an apparatus secured to a doorway.

FIG. 5 depicts an embodiment of a first connecting rod and a second connecting rod.

### DETAILED DESCRIPTION

The present disclosure relates to apparatuses and methods for locking doors. Unlike conventional door locks, the disclosed apparatuses and methods prevent intruders from breaking doors (e.g., kicking doors in) or compromising door locks to gain access to a room or escape a room. The disclosed apparatuses and methods can be implemented with any hinged door and can be designed to be portable or permanent.

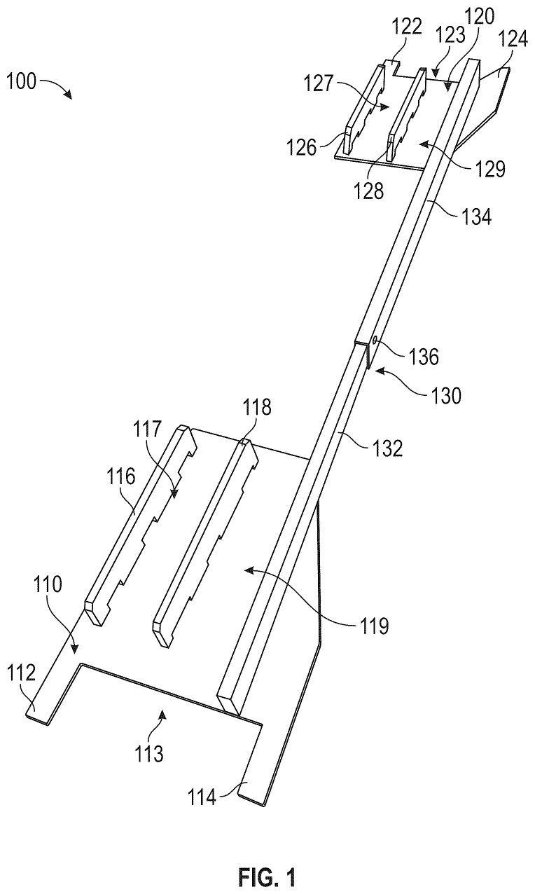

Turning to FIG. 1, an embodiment of an apparatus 100 for locking a door is depicted. The apparatus 100 includes a first base 110 and a second base 120. The first base 110 has a first connecting bar 132 coupled to a surface of the first base 110. The first base 110 also includes a door slot 117 that can be defined by a first set of rails (116, 118). The first base 110 can also include another door slot 119 that can be defined by the first connecting rod 132 and rail 118. The first base 110 can also include a cutout 113 that can be defined by a first set of protrusions (112, 114). The second base 120 has a second connecting bar 134 coupled to a surface of the second base 120. The second base 120 also includes a door slot 127 that can be defined by a second set of rails (126, 128). The second base 120 can also include another door slot 129 that can be defined by the second connecting rod 134 and rail 128. The second base 120 can also include a cutout 123 that is defined by a second set of protrusions (122, 124). The width of the door slots (117, 127) can be larger than the width of the cutouts (113, 123). In other words, the length of the first set of protrusions (112, 114) and the second set of protrusions (122, 124) is less than the width of the door slots (117, 127). In some embodiments, the apparatus 100, can have only a single door slot. The door slots (117, 127) can advantageously increase the security of the door by preventing the door from being forced open.

The first connecting bar 132 and the second connecting bar 134 are slidably engaged with each other and can form an adjustable connecting bar 130. The adjustable connecting bar 130 can have an aperture 136 formed by apertures in the first connecting bar 132 and the second connecting bar 134 being aligned. In the illustrative embodiment, the adjustable connecting bar 130 is in a plane parallel to the door (not illustrated) or has an angle of about 90 degrees with the ground. The adjustable connecting bar 130 can be configured such that the lock shackle of a lock is substantially or entirely contained within the adjustable connecting bar 130. For example, the adjustable connecting bar 130 can substantially contain the lock shackle when less than 10% of the length of the lock shackle is visible. Consequently, the adjustable connecting bar 130 would prevent the lock shackle from being compromised (e.g., cut with bolt cutters) and the door being unlocked.

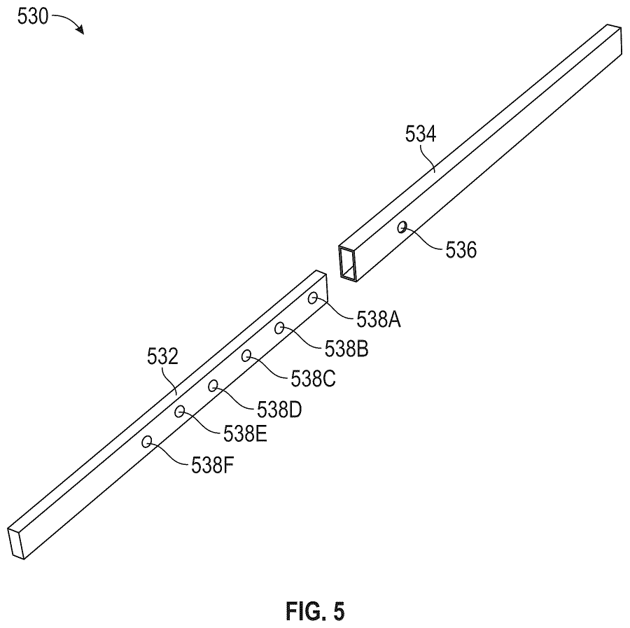

Turning to FIG. 5, the adjustable connecting bar 530 can include a plurality of apertures. In the illustrative embodiment, the first connecting bar 532 includes a plurality of apertures (538A, 538B, 538C, 538D, 538E, 538F), and the second connecting bar 534 has a single aperture 536. Each aperture of the plurality of apertures in the first connecting bar 532 corresponds to a width of a door. For example, the first aperture 538A can correlate to a 40-inch door, the second aperture 538B can correlate to a 36-inch door, the third aperture 538C can correlate to a 32-inch door, the fourth aperture 538D can correlate to a 30-inch door, the fifth aperture 538E can correlate to a 28-inch door, and the sixth aperture 538F can correlate to a 24-inch door. Thus, the aperture 536 of the second connecting rod 534 will align with one of the plurality of apertures based on the width of the door being locked. Although the illustrative embodiments in the figures depict the first connecting rod sliding within the second connecting rod, the apparatus can be configured such that the second connecting rod slides within the first connecting rod. Additionally, the apparatus can be configured such that the second connecting rod has a plurality of apertures and the first connecting rod has a single aperture. Additionally, the first connecting rod and the second connecting rod can each have a plurality of apertures.

Turning back to FIG. 1, when the apparatus 100 is implemented with doors having the hinges exposed on the interior side of the door, the apparatus 100 is slid underneath the bottom edge of the door such that the door is within the door slots (117, 127) and the adjustable connecting bar 130 is positioned on the exterior side of the door, allowing the user to lock the door by inserting a lock through aperture 136. This configuration is advantageous in situations where a user desires to prevent someone from opening the door from the inside, or when a user desires to secure a location while they depart for a period of time.

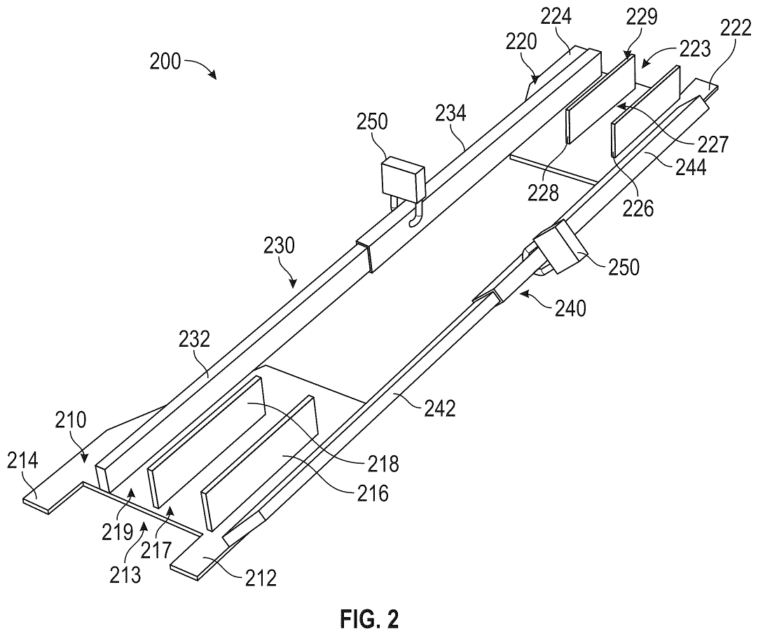

With reference to FIG. 2, an alternative embodiment of an apparatus 200 for locking a door is illustrated. The apparatus 200 includes a first base 210 and a second base 220. The first base 210 has a first connecting bar 232 and a door slot 217 defined by a first set of rails (216, 218). The first base 210 can also include another door slot 219 that can be defined by the first connecting rod 232 and rail 218. The first base also includes a cutout 213 that is defined by a first set of protrusions (212, 214). The second base 220 has a second connecting bar 234 and a door slot 227 defined by a second set of rails (226, 228). The second base 220 can also include another door slot 229 that can be defined by the second connecting rod 234 and rail 228. The second base also includes a cutout 223 that is defined by a second set of protrusions (222, 224). In some embodiments, the apparatus 200, can have only a single door slot. The door slots (217, 227) can advantageously increase the security of the door by preventing the door from being forced open.

In addition to the first adjustable connecting bar 230 formed by the first connecting bar 232 and the second connecting bar 234, the apparatus also includes a second adjustable connecting bar 240 formed by a third connecting bar 242 and a fourth connecting bar 244. The first adjustable connecting bar 230 and/or the second adjustable connecting bar 240 can be secured to a desired size by inserting a lock 250 through the apertures (not illustrated) in the first adjustable connecting bar 230 and/or the second adjustable connecting bar 240. The adjustable connecting bars (230, 240) can be configured such that the lock shackle of a lock is substantially or entirely contained within the adjustable connecting bars (230, 240). For example, the adjustable connecting bars (230, 240) can substantially contain the lock shackle when less than 10% of the length of the lock shackle is visible. Consequently, the adjustable connecting bars (230, 240) would prevent the lock shackle from being compromised (e.g., cut with bolt cutters) and the door being unlocked.

The depicted apparatus 200 is configured for exterior access and interior access. The apparatus 200 can be positioned such that the door is within the door slots (217, 227) and the first adjustable connecting bar 230 is positioned on the exterior side of the door and the second adjustable connecting bar 240 is on the interior side of the door. For exterior access, like FIG. 1, the lock 250 is placed on the first adjustable connecting bar 230. For interior access (e.g., locking a front door for the night), the lock 250 is placed on the second adjustable connecting bar 240.

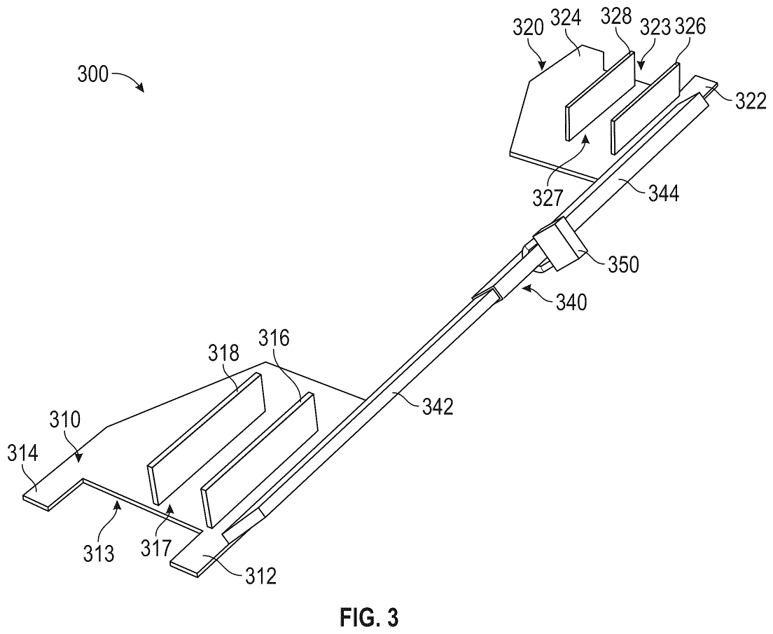

Turning to FIG. 3, an alternative embodiment of an apparatus 300 is illustrated. The apparatus 300 includes a first base 310 and a second base 320. The first base 310 has a first connecting bar 342 and a door slot 317 defined by a first set of rails (316, 318). The first base also includes a cutout 313 that is defined by a first set of protrusions (312, 314). The second base 320 has a second connecting bar 344 and a door slot 327 defined by a second set of rails (326, 328). The second base 320 also includes a cutout 323 that is defined by a second set of protrusions (322, 324). In some embodiments, the apparatus 300, can have only a single door slot. The door slots (317, 327) can advantageously increase the security of the door by preventing the door from being forced open.

The adjustable connecting bar 340 can be secured to a desired size by inserting a lock 350 through the apertures (not illustrated) in the first connecting bar 342 and the second connecting bar 344. The adjustable connecting bar 340 can be configured such that the lock shackle of a lock is substantially or entirely contained within the adjustable connecting bar 340. For example, the adjustable connecting bar 340 can substantially contain the lock shackle when less than 10% of the length of the lock shackle is visible. Consequently, the adjustable connecting bar 340 would prevent the lock shackle from being compromised (e.g., cut with bolt cutters) and the door being unlocked.

As seen in the depicted embodiment, the adjustable connecting bar 340 is positioned at an angle relative to the first and second bases (310, 320). This angled configuration allows a lock 350 to be inserted through the aligned aperture when the adjustable connecting bar 340 is positioned close to the first and second door slots (317, 327). If the adjustable connecting bar 340 were not angled in such a closely positioned configuration, the door located in the first and second door slots (317, 327) would prevent the lock 350 from being inserted through the aligned aperture. In one embodiment, the adjustable connecting bar 340 has an angle of less than 90 degrees with the door, an angle between about 30 degrees to about 60 degrees with the door, an angle of about 40 degrees to 50 degrees with the door, or any combination thereof.

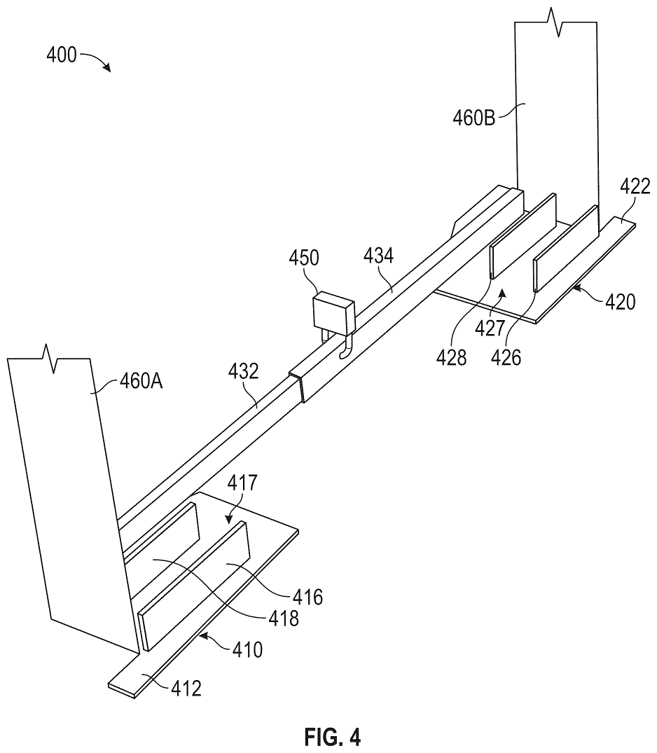

With reference to FIG. 4, an apparatus 400 is implemented with a door system. In the illustrative embodiment, the first base 410 is engaged with the first side 460A of the doorway, and the second base 420 is engaged with the second side 460B of the doorway. The first side 460A of the doorway fits into the first cutout (not illustrated) of the first base 410, which is defined by a first protrusion 412 and a second protrusion (not visible). The second side 460B of the doorway fits into the second cutout (not illustrated) of the second base 420, which is defined by a first protrusion 422 and a second protrusion (not visible). Although not depicted in the illustrative embodiment, the door would be positioned within the first door slot 417 and the second door slot 427, which are defined by a first set of rails (416, 418) and a second set of rails (426, 428), respectively. The first connecting bar 432 and the second connecting bar 434 are placed in an extended position that enables the cutouts of the first base 410 and the second base 420 to engage the doorway. A lock 450 is inserted through apertures in the first connecting bar 432 and the second connecting bar 434 to lock the apparatus in place.

### Example Methods of Operation

Example 1—Locking a Door from the Exterior. Referring to FIG. 1, an example method of locking a door from the exterior with apparatus 100 is described. In the instant method, the door is configured such that the hinges are located on the interior side of the door (e.g., the door opens into a room). The method begins by opening the door and sliding the apparatus 100 underneath the bottom edge of the door such that the door is positioned within the first door slot 117 and the second door slot 127. The adjustable connecting bar 130 is located on the exterior side of the door. The apparatus 100 should be configured such that the total length of the apparatus 100 (e.g., the distance between the first set of apertures (112, 114) and the second set of apertures (122, 124) is less than the width of the door).

After closing the door, the first base 110 and the second base 120 are secured to the door frame by sliding the bases (110, 120) toward the respective sides of the doorway. The cutouts (113, 123) of the bases (110, 120) engage the doorway, with the first set of protrusions (112, 114) and the second set of protrusions (122, 124) being secured around the sides of the doorway. When the bases (110, 120) are secured to the doorway, apertures in the first connecting bar 132 and the second connecting bar 134 will align, producing an aligned aperture 136. The aligned aperture 136 corresponds to the width of the door. Next, a lock is inserted through the aligned aperture 136. The door can be unlocked by removing the lock and disengaging the bases (110, 120) from the doorway. The bases (110, 120) can be disengaged by sliding them towards the center of the apparatus 100. Next, the user can open the door and slide the apparatus 100 out from the door.

Although the instant example was described with reference to FIG. 1, the apparatus shown and described in FIG. 2 can be implemented according to the method described in this example.

Example 2—Locking a Door from the Interior. Referring to FIG. 3, an example method of locking a door from the interior with apparatus 300 is described. In the instant method, the door is configured such that the hinges are located on the interior side of the door (e.g., the door opens into a room). The method begins by opening the door and sliding the apparatus 300 underneath the bottom edge of the door such that the door is positioned within the first door slot 317 and the second door slot 327. The adjustable connecting bar 340 is located on the interior side of the door. The apparatus 300 should be configured such that the total length of the apparatus 300 (e.g., the distance between the first set of apertures (312, 314) and the second set of apertures (322, 324) is less than the width of the door).

After closing the door, the first base 310 and the second base 320 are secured to the door frame by sliding the bases (310, 320) toward the respective sides of the doorway. The cutouts (313, 323) of the bases (310, 320) engage the doorway, with the first set of protrusions (312, 314) and the second set of protrusions (322, 324) being secured around the sides of the doorway. When the bases (310, 320) are secured to the doorway, apertures in the first connecting bar 342 and the second connecting bar 344 will align, producing an aligned aperture (not illustrated). The aligned aperture corresponds to the width of the door. Next, a lock 350 is inserted through the aligned aperture. The door can be unlocked by removing the lock and disengaging the bases (310, 320) from the doorway. The bases (310, 320) can be disengaged by sliding them towards the center of the apparatus 100. Next, the user can open the door and slide the apparatus 300 out from the door.

Although the instant example was described with reference to FIG. 3, the apparatus shown and described in FIG. 2 can be implemented according to the method described in this example.

As used herein, the term “about” can be understood as the disclosed values varying by 20-25%, 15-20%, 10-15%, 5-10%, 1-5%, or any combination thereof from the listed values.

Additionally, the section headings herein are provided for consistency with the suggestions under 37 C.F.R. § 1.77 or to provide organizational cues. These headings shall not limit or characterize the invention(s) set out in any claims that may issue from this disclosure. Specifically, and by way of example, although the headings refer to a “Technical Field,” the claims should not be limited by the language chosen under this heading to describe the so-called field. Further, a description of a technology as background information is not to be construed as an admission that a particular technology is prior art to any embodiment(s) in this disclosure. Neither is the “Summary”a characterization of the embodiment(s) outlined in issued claims.

Furthermore, any reference in this disclosure to “invention” in the singular should not be used to argue that there is only a single point of novelty in this disclosure. Multiple embodiments may be set forth according to the limitations of the multiple claims issuing from this disclosure. Such claims accordingly define the embodiment(s) and their equivalents that are protected thereby. In all instances, the scope of such claims shall be considered on their own merits in light of this disclosure but should not be constrained by the headings set forth herein.

Moreover, the Abstract is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the preceding Detailed Description, it can be seen that various features may be grouped in a single embodiment to streamline the disclosure. This method of disclosure is not to be interpreted as reflecting an intention that the claimed embodiments require more features than are expressly recited in each claim. Instead, as the claims reflect, the inventive subject matter lies in less than all features of a single disclosed embodiment. Thus, the following claims are incorporated into the Detailed Description, with each claim standing on its own as a separate embodiment.

What is claimed is:

1. An apparatus for locking a door, the apparatus comprising:
a first base comprising a first connecting bar and a first door slot to accommodate the door, wherein the first connecting bar comprises one or more apertures, the first base further comprising a first cutout to engage a first side of a door frame; and
a second base comprising a second connecting bar and a second door slot to accommodate the door, wherein the second connecting bar comprises one or more apertures, the second base further comprising a second cutout to engage an opposing second side of the door frame;
wherein the first connecting bar is slidably engaged with the second connecting bar, further wherein the one or more apertures of the first connecting bar are configured to align with the one or more apertures of the second connecting bar when the first cutout and the second cutout are engaged with the door frame, and further wherein the aligned apertures are configured to receive a lock.

2. The apparatus of claim 1, wherein the first base further comprises a first set of rails that define the first door slot, and wherein the second base further comprises a second set of rails that define the second door slot.

3. The apparatus of claim 1, wherein the first base comprises a first set of lateral protrusions that define the first cutout, and wherein the second base comprises a second set of lateral protrusions that define the second cutout.

4. The apparatus of claim 1, wherein the one or more apertures of the first connecting bar comprises a first aperture corresponding to a 24-inch door, a second aperture corresponding to a 28-inch door, a third aperture corresponding to a 30-inch door, a fourth aperture corresponding to a 32-inch door, and a fifth aperture corresponding to a 36-inch door.

5. The apparatus of claim 4, wherein the one or more apertures of the second connecting bar comprises a single aperture.

6. The apparatus of claim 1, wherein the first connecting bar is sized and configured to slide within the second connecting bar.

7. The apparatus of claim 4, wherein the first connecting bar and the second connecting bar substantially contain a lock shackle of the lock.

8. The apparatus of claim 4, wherein the apparatus is configured to slide under a bottom end of the door.

9. The apparatus of claim 1, wherein the apparatus is configured to slide over a top end of the door.

10. The apparatus of claim 1, wherein the first connecting bar and the second connecting bar are positioned on an exterior side of the door.

11. The apparatus of claim 10, wherein the first connecting bar and the second connecting bar are in a parallel plane with the door.

12. The apparatus of claim 1, wherein the first connecting bar and the second connecting bar are positioned on an interior side of the door.

13. The apparatus of claim 12, wherein the first connecting bar and the second connecting bar are in a plane having an angle of less than 90 degrees with the door.

14. The apparatus of claim 13, wherein the angle is between about 30 degrees to about 60 degrees.

15. A method for locking a door with an apparatus, the method comprising:
positioning the door within a door slot of the apparatus;
closing the door against a door frame;
securing a first base of the apparatus with a first side of the door frame;
securing a second base of the apparatus with an opposing second side of the door frame, wherein a first connecting bar of the first base is slidably engaged with a second connecting bar of the second base, whereby an aperture in the first connecting bar is aligned with an aperture in the second connecting bar; and
inserting a lock shackle of a lock through the aligned apertures, thereby locking the door.

16. The apparatus of claim 15, wherein positioning the door within the door slot comprises sliding the apparatus underneath the door.

17. The apparatus of claim 15, wherein positioning the door within the door slot comprises sliding the apparatus over a top of the door.

18. The apparatus of claim 15, wherein securing the first base of the apparatus with the first side of the door frame comprises extending the first base away from a center of the apparatus, and wherein securing the second base of the apparatus with the second side of the door frame comprises extending the second base away from the center of the apparatus.

19. The apparatus of claim 16, wherein positioning the door within the door slot further comprises the first connecting bar and the second connecting bar being positioned on an exterior side of the door.

20. The apparatus of claim 16, wherein positioning the door within the door slot further comprises the first connecting bar and the second connecting bar being positioned on an interior side of the door.
